(19) United States
(12) Patent Application Publication
(10) Pub. No.: US 2009/0092901 A1
(43) Pub. Date: Apr. 9, 2009

(54) TI-NI ALLOY-NI SULFIDE ELEMENT FOR COMBINED CURRENT COLLECTOR-ELECTRODE

(76) Inventors: Tae-Hyun Nam, Gyeongsangnam-do (KR); Hyo-Jun Ahn, Gyeongsangnam-do (KR); Ki-Won Kim, Gyeongsangnam-do (KR); Kwon-Koo Cho, Gyeongsangnam-do (KR); Jou-Hyeon Ahn, Gyeongsangnam-do (KR); Gyu-Bong Cho, Gyeongsangnam-do (KR); Cheol Am Yu, Gyeongsangnam-do (KR)

Correspondence Address: BIRCH STEWART KOLASCH & BIRCH, PO BOX 747, FALLS CHURCH, VA, 22040-0747, US

(21) Appl. No.: 12/297,852

(22) PCT Filed: Jul. 25, 2006
(86) PCT No.: PCT/KR2006/002926

§ 371 Date: Oct. 20, 2008

(30) Foreign Application Priority Data
Jun. 2, 2006 (KR) 10-2006-0049938

(51) Int. Cl. H01M 4/52

(52) U.S. Cl. 429/223

(57) ABSTRACT

The present invention relates to a superelastic alloy-Ni sulfide element for a combined current collector-electrode in which Ti—Ni based alloy is used as a current collector and Ni sulfide is used as electrode material, the Ni sulfide being formed on the Ti—Ni based alloy by forming a Ni thin film on a surface of the Ti—Ni based alloy and sulfurdizing the Ti—Ni based alloy comprising the Ni thin film. Thus, a superelastic characteristic of the element is realized as well as small-size integration of a battery is possible.

### TECHNICAL FIELD

The present invention relates to a combined current collector-electrode element, and more particularly, to a superelastic alloy-Ni sulfide element for a combined current collector-electrode in which Ti—Ni based alloy is used as a current collector and Ni sulfide is used as electrode material, the Ni sulfide being formed on the Ti—Ni based alloy by forming a Ni thin film on a surface of the Ti—Ni based alloy and sulfurdizing the Ti—Ni based alloy comprising the Ni thin film.

### BACKGROUND ART

In general, a battery includes an anode, a cathode, an electrolyte, and a current collector. Among them, the current collector serves to collect electricity created in the battery at the time of discharging. The cathode performs a reducing reaction by electrons generated in the anode. As current collector material presently, there are copper (Cu), stainless steel, etc. As anode material, there are metal oxide, sulfide, hydroxide, etc.

A recent variable battery being increasing in use scope has a characteristic of being capable of varying a battery form depending on the purpose of use. However, the conventional current collector using copper or stainless steel has a drawback that a repeated shape variation causes plastic strain and thus work hardening, thereby resulting in hardening and fracturing of the current collector.

Attempts have been made to manufacture a current collector and an electrode in a combination form for the purpose of small-size integration of a battery. Among them, one method is to process a current collector by electrode material directly. However, this method causes several drawbacks. Particularly, in case where Ti—Ni alloy, which is superelastic alloy, is used as current collector material and sulfide is used as electrode material, a combined current collector-electrode element can be manufactured by sulfurdizing the electrode material itself, but there occurs a drawback that Ti sulfide is unnecessarily created in addition to Ni sulfide required by the element.

The present inventors have repeatedly studied and attained the present invention for the purpose of solving the drawbacks and giving a current collector a superelastic effect while manufacturing the current collector in combination with an electrode and manufacturing a small-size integrated element.

### DISCLOSURE

### Technical Problem

Accordingly, the present invention is directed to a Ti—Ni alloy-Ni sulfide element for a combined Current collector-electrode that substantially obviates one or more of the problems due to limitations and disadvantages of the related art.

An object of the present invention is to provide a metal-metal sulfide element for a combined current collector-cathode having a superelastic characteristic in which alloy with a superelastic characteristic is used as a current collector and Ni sulfide is formed as electrode material on a surface of the current collector.

### Technical Solution

To achieve these and other advantages and in accordance with the purpose of the present invention, as embodied and broadly described, there is provided a Ti—Ni based alloy-Ni sulfide element for a combined current collector electrode. In the Ti—Ni based alloy-Ni sulfide element, Ti—Ni based superelastic alloy thin plate and wire are used as current collector material and Ni sulfide is used as anode material. The Ni sulfide is formed by forming a Ni thin film on a surface of the current collector and sulfurdizing the Ti—Ni based alloy.

The present invention provides a Ti—Ni based alloy-Ni sulfide element for a combined current collector-electrode. Ti—Ni based alloy is used as current collector material and Ni sulfide is used as electrode material. The Ni sulfide is formed on the Ti—Ni based alloy by forming a Ni thin film on a surface of the Ti—Ni based alloy and sulfurdizing the Ti—Ni based alloy comprising the Ni thin film.

In the present invention, alloy having a superelastic effect and used as a current collector is Ti—Ni binary alloy or Ti—Ni—X ternary alloy, and X is equal to Fe (0.1 at % to 2.0 at %), Al (0.1 at % to 2.0 at %), Mo (0.1 at % to 2.5 at %), Co (0.05 at % to 1.5 at %), Cr (0.05 at % to 1.5 at %), - - - V (0.1 at % to 2.5 at %), Cu (1.0 at % to 25.0 at %), Mn (0.05 at % to 1.5 at %), Hf (1.0 at % to 25.0 at %), or Zr (1.0 at % to 25.0 at %). The Ti—Ni—X ternary alloy is known as all having a similar superelastic characteristic. Exemplary superelastic alloy is Ti—Ni alloy, Ti—Ni—Mo alloy, Ti—Ni—Cu alloy, or Ti—Ni—Cr alloy.

Superelastic effect means a phenomenon in which an element is deformed by applying a stress to a parent phase that is a high temperature phase and creating stress induced Martensite and then, the element is restored to an original shape by relieving the stress. FIG. 3 shows a superelastic effect of Ti-Ni alloy. If alloy is stressed after being heated and made in a parent phase, the alloy is strained about 3% by stress induced Martensite transformation. After that, if the stress is relieved, Martensite changes into a parent phase while a strain rate is completely restored.

In order to manufacture a combined current collector-electrode element, a Ni thin film is coated and sulfurdized on a surface of the current collector. The sulfurdizing is performed by heat treatment in a vacuum atmosphere. The sulfurdizing is performed by charging Ti—Ni based alloy and solid-state sulfur and then, heating the Ti—Ni based alloy at 400° C. to 700° C. for 10 to 30 hours. Below 400° C. or below 10 hours, sulfide is instably created. Above 700° C., oxidation occurs. Above 30 hours, an amount of created sulfide does not almost change though time lapses.

A schematic structure of the above manufactured superelastic alloy-Ni sulfide element for a plate or wire type combined current collector-cathode according to the present invention is shown in FIGS. 1 and 2.

### ADVANTAGEOUS EFFECTS

The inventive element is constructed in a combined current collector-electrode form by using Ti—Ni based alloy as current collector material, forming a Ni thin film on a surface of the Ti—Ni based alloy, sulfurdizing the Ti—Ni based alloy comprising the Ni thin film, and forming sulfide, thereby realizing a superelastic characteristic of the element. In addition, this enables a small size integration of a battery and the element is very useful in the case of being used in related industries.

### DESCRIPTION OF DRAWINGS

FIG. 1 is a conceptive diagram illustrating a combined current collector-cathode superelastic plate type alloy-Ni sulfide element;

FIG. 2 is a conceptive diagram illustrating a combined current collector-cathode superelastic wire type alloy-Ni sulfide element;

FIG. 3 is a graph illustrating a superelastic characteristic of Ti-Ni alloy;

FIG. 4 is an X-ray diffraction diagram of a Ti—Ni—Mo alloy-Ni sulfide element according to the present invention;

FIG. 5 is a graph illustrating a superelastic characteristic of a Ti—Ni—Cu alloy-Ni sulfide element; and

FIG. 6 is a graph illustrating a battery characteristic of a Ti—Ni—Cr alloy-Ni sulfide element according to the present invention.

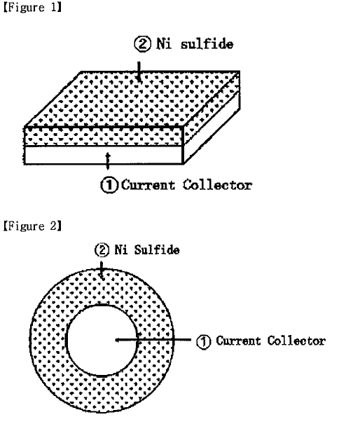

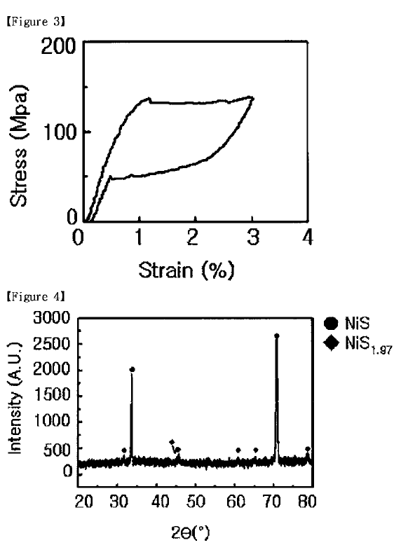

### BEST MODE

### First Exemplary Embodiment

A combined current collector-cathode element of Ti—Ni—Mo alloy/Ni sulfide was manufactured by using Ti—Ni—Mo alloy as current collector material, forming a Ni thin film on a surface of the Ti—Ni—Mo alloy, charging the Ti—Ni—Mo alloy comprising the Ni thin film together with solid-state sulfur, and heating the Ti—Ni—Mo alloy at 400° C. to 700° C. for 10 to 30 hours, and sulfurdizing the Ti—Ni—Mo alloy. An experimental result of X-ray diffraction for a surface of the element is shown in FIG. 4. As shown in FIG. 4, it can be confirmed that Ni sulfide is formed on the surface of the element.

In addition, a similar result can be obtained even in Ti—Ni binary alloy having the same physical property such as a superelastic characteristic and Ti—Ni—X ternary alloy (X: Fe (0.1 at % to 2.0 at %), Al (0.1 at % to 2.0 at %), Co (0.05 at % to 1.5 at %), Cr (0.05 at % to 1.5 at %), V (0.1 at % to 2.5 at %), Cu (1.0 at % to 25.0 at %), Mn (0.05 at % to 1.5 at %), Hf (1.0 at % to 25.0 at %), or Zr (1.0 at % to 25.0 at %)).

### MODE FOR INVENTION

### Second Exemplary Embodiment

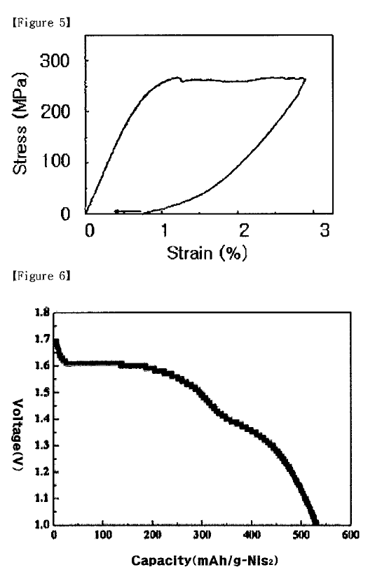

A combined current collector-cathode element was manufactured by using Ti—Ni—Cu alloy as current collector material in the same method as that of the first exemplary embodiment. A superelastic characteristic for the manufactured combined current collector cathode element is shown in FIG. 5. As shown in FIG. 5, it can be appreciated that the combined current collector-cathode element has a superelastic characteristic similar with that before sulfurdizing.

In addition, a similar result can be obtained even in Ti—Ni binary alloy having the same physical property such as a superelastic characteristic and Ti—Ni—X ternary alloy (X: Fe (0.1 at % to 2.0 at %), Al (0.1 at % to 2.0 at %), Mo (0.1 at % to 2.5 at %), Co (0.05 at % to 1.5 at %), Cr (0.05 at % to 1.5 at %), V (0.1 at % to 2.5 at %), Mn (0.05 at % to 1.5 at %), Hf (1.0 at % to 25.0 at %), or Zr (1.0 at % to 25.0 at %)).

### Third Exemplary Embodiment

A combined current collector cathode element was manufactured by using Ti—Ni—Cu alloy as current collector material in the same method as that of the first exemplary embodiment. A superelastic characteristic for the manufactured combined current collector-cathode element is shown in FIG. 6.

In addition, a similar result can be obtained even in Ti-Ni binary alloy having the same physical property such as a superelastic characteristic and Ti—Ni—X ternary alloy (X: Fe (0.1 at % to 2.0 at %), Al (0.1 at % to 2.0 at %), Mo (0.1 at % to 2.5 at %), Co (0.05 at % to 1.5 at %), V (0.1 at % to 2.5 at %), Cu (1.0 at % to 25.0 at %), Mn (0.05 at % to 1.5 at %), Hf (1.0 at % to 25.0 at %), or Zr (1.0 at % to 25.0 at %)).

### INDUSTRIAL APPLICABILITY

The inventive element is constructed in a combined current collector-electrode form by using Ti—Ni based alloy as current collector material, forming a Ni thin film on a surface of the Ti—Ni based alloy, sulfurdizing the Ti—Ni based alloy comprising the Ni thin film, and forming sulfide, thereby realizing a superelastic characteristic of the element. In addition, this enables a small-size integration of a battery and the element is very useful in the case of being used in related industries.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A Ti—Ni based alloy-Ni sulfide element for a combined current collector-electrode,
wherein Ti—Ni based alloy is used as current collector material, and Ni sulfide is used as electrode material,
wherein the Ni sulfide is formed on the Ti—Ni based alloy by forming a Ni thin film on a surface of the Ti—Ni based alloy, charging the Ti—Ni based alloy comprising the Ni thin film together with solid-state sulfur, heating the Ti—Ni based alloy at 400° C. to 700° C. for 10 to 30 hours, and sulfurdizing the Ti—Ni based alloy.

2. The element of claim 1, wherein the Ti—Ni based alloy is Ti—Ni binary alloy or Ti—Ni—X ternary alloy, and X is equal to Fe (0.1 at % to 2.0 at %), Al (0.1 at % to 2.0 at %), Co (0.05 at % to 1.5 at %), Cr (0.05 at % to 1.5 at %), Mo (0.1 at % to 2.5 at %), V (0.1 at % to 2.5 at %), Cu (1.0 at % to 25.0 at %), Mn (0.05 at % to 1.5 at %), Hf (1.0 at % to 25.0 at %), or Zr (1.0 at % to 25.0 at %).
